(19) United States
(12) Patent Application Publication
(10) Pub. No.: US 2014/0095746 A1
(43) Pub. Date: Apr. 3, 2014

(54) Information Processing Apparatus, computer readable storage medium, and Key Assignment Changing Method

(71) Applicant: Kabushiki Kaisha Toshiba, Tokyo (JP)

(72) Inventor: Akihiko Noguchi, Ome-shi (JP)

(73) Assignee: Kabushiki Kaisha Toshiba, Tokyo (JP)

(21) Appl. No.: 13/951,171

(22) Filed: Jul. 25, 2013

(30) Foreign Application Priority Data
Sep. 28, 2012 (JP) 2012-218789

(51) Int. Cl. G06F 13/10

(52) U.S. Cl. CPC G06F 13/10
USPC 710/67

(57) ABSTRACT

An information processing apparatus includes a transmitter, a receiver, and a key assignment changing module. The transmitter is configured to transmit information relating to a use situation of the information processing apparatus to an external storage device. The receiver is configured to receive, from the external storage device, key assignment information which is based on the information relating to the use situation and transmitted by the transmitter. The key assignment changing module is configured to change a key assignment of a keyboard connected to the information processing apparatus based on the received key assignment information.

### CROSS-REFERENCE TO RELATED APPLICATION(S)

The present disclosure claims priority to Japanese Patent Application No. 2012-218789, filed on Sep. 28, 2012, which is incorporated herein by reference in its entirety.

### FIELD

Embodiments described herein relate generally to an information processing apparatus, a computer readable storage medium, and a key assignment changing method.

### BACKGROUND

With the recent advancement of technologies, sharing of a PC (personal computer) and use of plural PCs by a single person have become common practices. Furthermore, there are users each applying a favorite key assignment to the predetermined keyboard of his or her PC. However, when such a user uses another PC, the other PC to which his or her favorite key assignment is not applied is inconvenient to the user and hence, the work efficiency may be lowered.

### BRIEF DESCRIPTION OF THE DRAWINGS

FIG. 1 is a conceptual diagram showing an example of the configuration of a system according to one embodiment;

FIG. 2 shows an example of the system configuration of each PC according to the embodiment;

FIG. 3 is a conceptual table showing key-assignment correspondence information stored in a key assignment storage device according to the embodiment;

FIG. 4 is a block diagram showing an example of the functional configuration of each PC according to the embodiment; and

FIG. 5 is a flowchart of an example of a process which is executed by each PC according to the embodiment.

### DETAILED DESCRIPTION

According to one embodiment, an information processing apparatus includes a transmitter, a receiver, and a key assignment changing module. The transmitter is configured to transmit information relating to a use situation of the information processing apparatus to an external storage device. The receiver is configured to receive, from the external storage device, key assignment information which is based on the information relating to the use situation and transmitted by the transmitter. The key assignment changing module is configured to change a key assignment of a keyboard connected to the information processing apparatus based on the received key assignment information.

Embodiments will be hereinafter described with reference to the accompanying drawings.

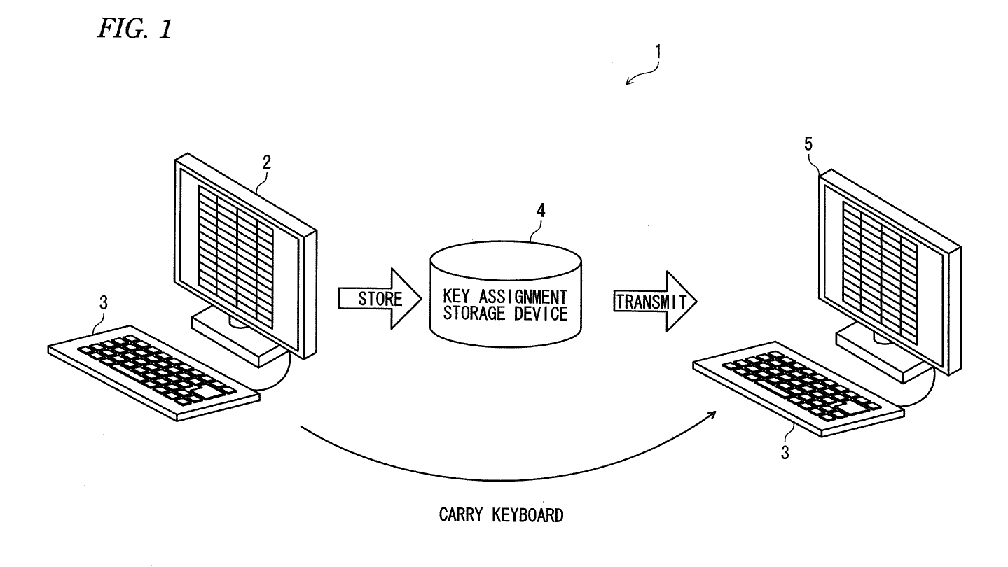

FIG. 1 is a conceptual diagram showing an example of the configuration of a system 1 according to the embodiment.

The system 1 is one that provides a key assignment which is suitable for a user.

A PC (personal computer) 2 is an example of an information processing apparatus. A user ‘A’ is personally uses the PC 2. The user uses the PC 2 usually in such a manner that a keyboard 3 is connected thereto.

The keyboard 3 is provided with plural keys and an example of an input device. The keyboard 3 has a function of transmitting a signal about a key pushed by the user to the connected PC2 by wire or wirelessly.

The PC 2 can apply a key assignment(s) that are different from one(s) that are generally applied to the keyboard 3. For example, the PC 2 can disable a predetermined key or assign the CTRL key to the CAPSLOCK key. Where the CTRL key is assigned to the CAPSLOCK key, when the user pushes the CAPSLOCK key of the keyboard 3, the PC 2 behaves as if the CTRL key were pushed. When the CAPSLOCK key is pushed, the keyboard 3 according to this embodiment transmits an electric signal corresponding to the CAPSLOCK key to the PC 2, but the PC 2 operates with recognizing this signal as indicating that the CTRL key is pushed, because the CTRL key is assigned to the CAPSLOCK key. On the other hand, where a predetermined key is disabled, even if the PC 2 receives a signal corresponding to the predetermined key from the keyboard 3, the PC 2 disregards the signal and does no operation. In this manner, the PC 2 can apply to the keyboard 3 a key assignment(s) that are different from the default one(s).

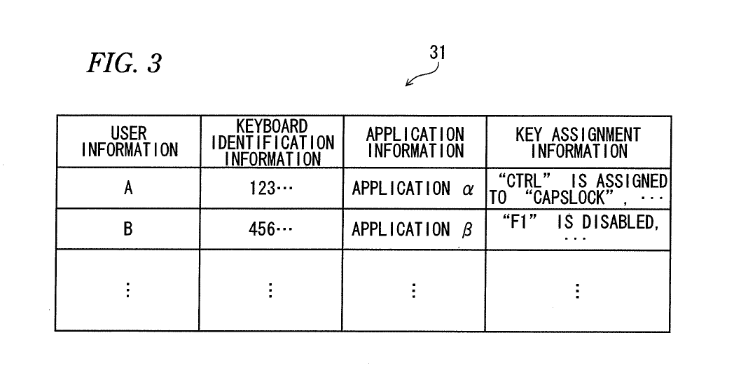

A key assignment storage device 4, which is an external storage device of the PC 2, is a database (DB) that stores therein information of a key assignment(s) applied by the PC 2 (hereinafter the information may be referred to as “key assignment information”). The key assignment storage device 4 is implemented by, for example, a nonvolatile memory and exists on a network to which plural PCs are connected. The key assignment storage device 4 has a function of storing therein the key assignments transmitted from the PC 2 and the like in association with user information, keyboard identification information, information of a prescribed application, etc. The key assignment storage device 4 also has a function of transmitting key assignment information to a PC upon receipt of a request for the key assignment information from the PC. The key assignment storage device 4 will be described later in detail with reference to FIG. 3.

A PC 5 has approximately the same internal configuration and functions as the PC 2 and is another example of the information processing apparatus. The PC 5 can apply to a keyboard connected thereto a key assignment(s) that are different from a default one(s).

In the system shown in FIG. 1, the keyboard 3 can be used with being connected to each of the PCs 2 and 5. There may be a case where the user ‘A’ causes the PC 2 to apply a predetermined key assignment(s), then carries the keyboard 3, and connects the keyboard 3 to the PC 5 for use. Even in such a case, the system 1 allows the user to use, with the PC 5, the key assignment(s) that were applied by the PC 2. An outline of a process is such that the PC 2 stores information of an applied key assignment(s) in the key assignment storage device 4, and the PC 5 acquires this key assignment information from the key assignment storage device 4 for application.

Next, the internal configuration of the PC 2 will be described.

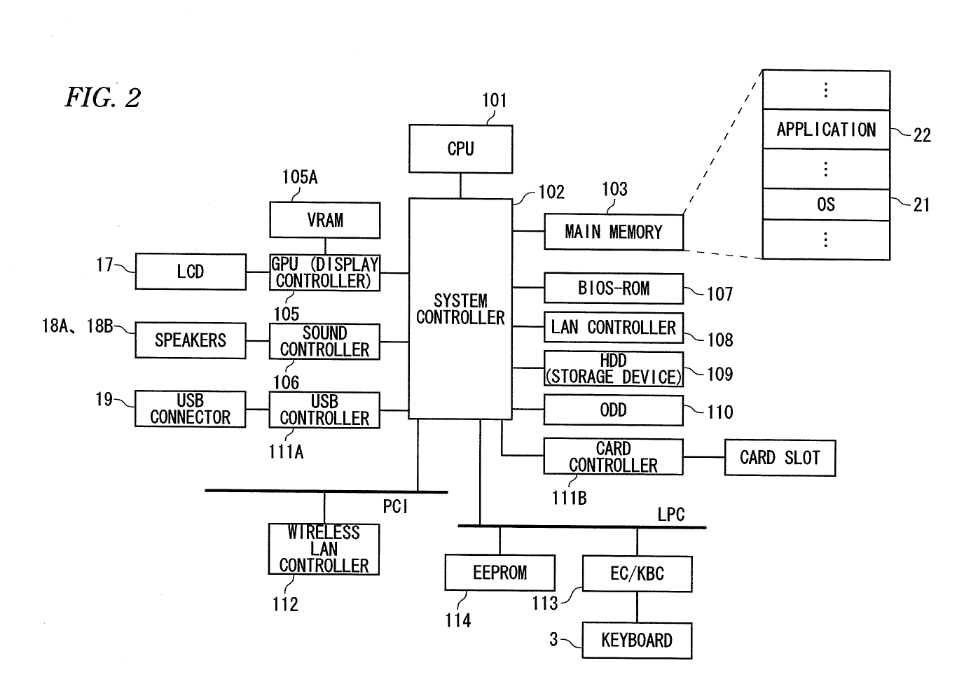

FIG. 2 shows an example of the system configuration of the PC 2 according to this embodiment.

As shown in FIG. 2, the PC 2 is equipped with a CPU 101, a system controller 102, a main memory 103, a graphics processing unit (GPU) 105, a video RAM (VRAM) 105A, a sound controller 106, a BIOS-ROM 107, a LAN controller 108, a hard disk drive (HDD) 109, an optical disc drive (ODD) 110, a USB controller 111A, a card controller 111B, a wireless LAN controller 112, an embedded controller/keyboard controller (EC/KBC) 113, an EEPROM 114, etc.

The CPU 101 is a processor that controls operations of individual components of the PC 2. The CPU 101 runs an operating system (OS) 21, various utility programs, and various application programs which are loaded into the main memory 103 from the HDD 109. The various utility programs include an application program 22 and the like.

The application program 22 is, for example, a spread sheet program. FIG. 1 shows screens on which an application program 22 is executed.

The CPU 101 also runs a BIOS that is stored in the BIOS-ROM 107. The BIOS is programs for hardware control.

The system controller 102 is a bridge device that connects a local bus of the CPU 101 to the individual components. The system controller 102 incorporates a memory controller for access-controlling the main memory 103. The system controller 102 also has a function of communicating with the GPU 105 via, for example, a serial bus that complies with the PCI Express standard or the like.

The GPU 105 is a display controller that controls an LCD 17 which is used as a display monitor of the PC 2. A display signal generated by the GPU 105 is transmitted to the LCD 17.

The system controller 102 controls individual devices on a PCI (peripheral component interconnect) bus and individual devices on an LPC (low pin count) bus. The system controller 102 incorporates an IDE (integrated drive electronics) controller for controlling the HDD 109 and the ODD 110. The system controller 102 also has a function of communicating with the sound controller 106.

The sound controller 106 is a sound source device and outputs audio data to be reproduced to speakers 18A and 18B. The LAN controller 108 is a wired communication device that performs a wired communication according to the IEEE 802.3 standard, for example. On the other hand, the wireless LAN controller 112 is a wireless communication device that performs a wireless communication according to the IEEE 802.11 standard, for example. The USB controller 111A communicates with an external device (connected thereto via a USB connector 19). The card controller 111B writes and reads data to and from a memory card that is inserted into a card slot that is formed in the computer main body of the PC 2.

The EC/KBC 113 is a one-chip microcomputer in which an embedded controller for power management and a keyboard controller for controlling the keyboard 3 are integrated together.

The internal configuration of the PC 5 is approximately the same as that of the PC 2. Therefore, description thereon will be omitted.

Next, information that is stored in the key assignment storage device 4 will be described.

FIG. 3 is a conceptual table showing an example of key-assignment correspondence information 31 that is stored in the key assignment storage device 4.

Key-assignment correspondence information 31 is information in which key assignment information, user information, keyboard identification information, and application information are associated with each other. Although in the embodiment these four kinds of information are associated with each other to constitute the key-assignment correspondence information 31, other information may be associated. Alternatively, only part of the four kinds of information may be associated with each other. In other words, the key-assignment correspondence information 31 includes any information so long as the key assignment information is associated with information other than the key assignment information.

The user information is information such as user log-in information and is used for identifying a user who uses a PC.

The keyboard identification information is information such as a serial number that is assigned to a keyboard when the keyboard is manufactured, and is used for identifying each keyboard.

The application information is information of an application that a user uses.

The key assignment information is information relating to a key assignment that has been changed when a user used a PC. As mentioned above, examples of the key assignment information include information to the effect that a predetermined key (e.g., the CTRL key) is assigned to another key (e.g., CAPSLOCK key) and information to the effect that a predetermined key (e.g., the F1 key) is disabled.

Any of the user information, the keyboard identification information, and the application information or a combination of plural kinds of information selected from among the user information, the keyboard identification information, and the application information are examples of information relating to a use situation of a PC.

As mentioned above, the key assignment storage device 4 stores the key assignment information, the user information, the keyboard identification information, the application information, and the like in association with each other. When receiving an instruction to store a key assignment(s) from the PC 2, for example, the key assignment storage device 4 acquires, from the PC 2, information of the key assignment(s), the user information of a user who wants to use this key assignment(s), the key board identification information of a keyboard to which the key assignment(s) are applied, and information of an application to which the key assignment(s) are applied and stores these information in association with each other.

Upon receipt of a request for the key assignment information from the PC 5, for example, the key assignment storage device 4 acquires from the PC 5 the user information of a user who is currently using the PC 5, the keyboard identification information of a keyboard which is being used, the application information of an application which is currently being used, and the like. If key assignment information corresponding to the acquired information exists in the key-assignment correspondence information 31, the key assignment storage device 4 transmits the key assignment information to the PC 5. The PC 5 makes the key assignment effective using the received key assignment information. Thereby, the user can use, on the PC 5, the key assignment which is convenient to him or her.

Various combinations of information may be conceived as combinations of information used at this time. For example, if the user information, the keyboard identification information, and the application information match, the key assignment may be applied based on the key assignment information. Alternatively, if even one of these (the user information, the keyboard identification information, or the application information) matches, the key assignment may be applied. Further alternatively, a combination of two of these (e.g., the user information and the keyboard identification information, the user information and the application information, or the keyboard identification information and the application information) matches, the key assignment may be applied.

Next, the internal functions of the PCs 2 and 5 will be described.

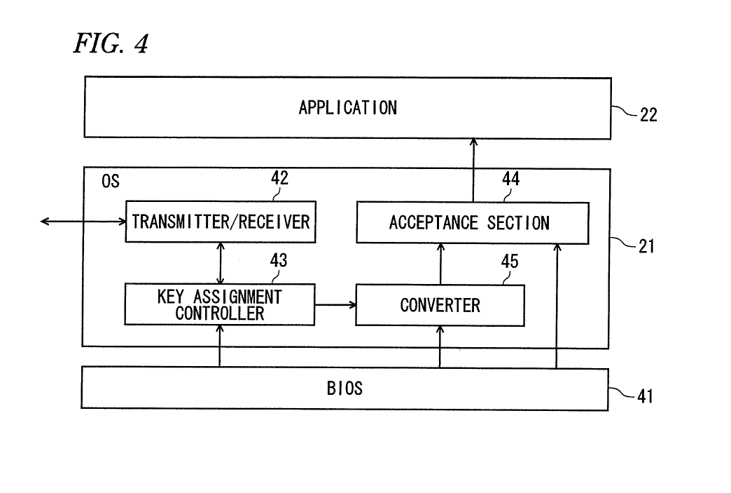

FIG. 4 is a block diagram showing an example of the functional configuration of the PC 2 according to this embodiment. The functional configuration of the PC 5 is approximately the same as that of the PC 2. Therefore, description thereon will be omitted.

The BIOS 41, which is run by the CPU 101, has functions of receiving an input signal from the keyboard 3 via the EC/KBC 113 and transmitting the input information to the OS 21.

A transmitter/receiver 42, for example, has a function of exchanging the key-assignment correspondence information 31 with the key assignment storage device 4 via the LAN controller 108, the wireless LAN controller 112, or the like.

A key assignment controller 43 has functions of controlling a key assignment changing process and exchanging information about the key-assignment correspondence information 31 with the key assignment storage device 4 via the transmitter/receiver 42.

The key assignment controller 43 executes the key assignment changing process in two situations. The first situation is that changing a key assignment(s) is instructed directly by the user who uses the PC 2. In this case, the key assignment controller 43 changes a key assignment setting on the PC 2 and instructs a converter 45 to change the key assignment(s) based on this change information. Also, the key assignment controller 43 associates the user information, the keyboard identification information, and the application information after the setting change with the key assignment information and transmits those information as the key-assignment correspondence information 31 to the key assignment storage device 4 via the transmitter/receiver 42. Then, the key assignment controller 43 instructs the key assignment storage device 4 to store the key-assignment correspondence information 31 therein.

The second situation in which the assignment control section 43 performs the key assignment changing process is that any of the user information, the keyboard identification information, and the application information is changed and the key assignment information corresponding to the change result has been stored in the key assignment storage device 4. If the key-assignment correspondence information 31 relating to the change result has been stored in the key assignment storage device 4, the key assignment controller 43 acquires the corresponding key assignment information from the key assignment storage device 4 via the transmitter/receiver 42, changes a setting(s) of the key assignment(s) based on the acquired key assignment information, stores the changed setting(s) of the key assignment(s), and instructs the converter 45 to change the key assignment(s).

An acceptance section 44 has functions of receiving keyboard input information that is transmitted from the BIOS 41 or the converter 45 and transmitting the received keyboard input information to the application 22.

The converter 45 has the following function. When a key assignment(s) have been changed from default one, the converter 45 hooks the key input information from the BIOS 41 to the acceptance section 44, converts this input information into changed input information, and transmits the changed input information to the acceptance section 44. According to the example described above, where the CTRL key is assigned to the CAPSLOCK key, the converter 45 hooks input information of the CAPSLOCK key, converts the input information of the CAPSLOCK key into input information of the CTRL key, and transmits the input information of the CTRL key to the acceptance section 44. Also, where the F1 key is disabled, the converter 45 hooks input information of the F1 key and transmits no information to the acceptance section 44.

Next, description will be given on a process procedure according to this embodiment.

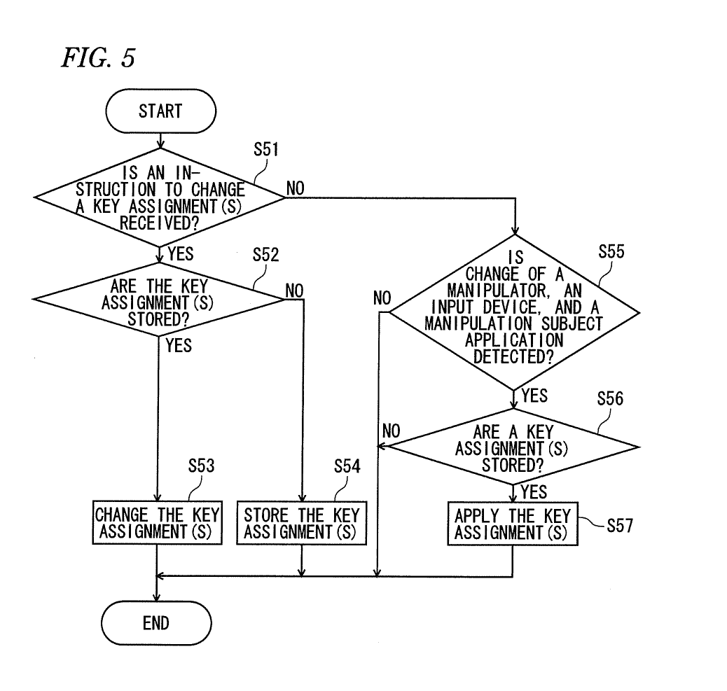

FIG. 5 is a flowchart of an example of a process which is executed by the PC 2 or the PC 5 according to the embodiment.

At step S51, the key assignment controller 43 determines as to whether or not an instruction to change a key assignment(s) is received from a user.

If determining at step S51 that the instruction to change the key assignment(s)is received (Yes at step S51), at step S52 the key assignment controller 43 inquires of the key assignment storage device 4 as to whether or not the key-assignment correspondence information 31 corresponding to the user who is currently using the PC 2 or 5, a keyboard which is being currently used, and an application which is being currently used is stored therein and determines as to whether or not such key-assignment correspondence information 31 is stored in the key assignment storage device 4.

If determining at step S52 that such key-assignment correspondence information 31 is stored in the key assignment storage device 4 (Yes at step S52), at step S53 the key assignment controller 43 transmits, to the key assignment storage device 4, user information of the user who is currently using the PC 2 or 5, keyboard identification information of the keyboard which is being currently used, application information of the application which is being currently used, and key assignment information and instructs the key assignment storage device 4 to change the key-assignment correspondence information 31 based on these information.

If determining at step S52 that no such key-assignment correspondence information 31 is stored in the key assignment storage device 4 (No at step S52), at step S54 the key assignment controller 43 transmits, to the key assignment storage device 4, the user information of the user who is currently using the PC 2 or 5, the keyboard identification information of the keyboard which is being currently used, the application information of the application which is being currently used, and the key assignment information and instructs the key assignment storage device 4 to store (i.e., newly register) key-assignment correspondence information 31 including these information.

If determining that no instruction to change a key assignment(s) is received (No at step S51), at step S55 the key assignment controller 43 determines as to whether or not the user (an example of a manipulator) who is using the PC 2 or 5, the keyboard (an example of the input device) which is being used, or the application which is being used is changed.

If detecting at step S55 that the user (an example of the manipulator), the keyboard (an example of the input device) which is being used, or the application which is being used is changed (Yes at step S55), at step S56 the key assignment controller 43 determines as to whether or not key-assignment correspondence information 31 corresponding to the user who is currently using the PC 2 or 5, the keyboard which is being currently used, and the application which is being currently used is stored in the key assignment storage device 4.

If determining that such key-assignment correspondence information 31 corresponding to the user who is currently using the PC 2 or 5, the keyboard which is being currently used, and the application which is being currently used is stored in the key assignment storage device 4 (Yes at step S56), at step S57 the key assignment controller 43 applies the key assignment(s) to the PC 2 or 5. In other words, the key assignment controller 43 acquires, from the key assignment storage device 4, the key assignment information corresponding to the user who is currently using the PC 2 or 5, the keyboard which is being currently used, and the application which is being currently used and instructs the converter 45 to change the key assignment(s) based on the acquired key assignment information. This allows the user to work with the PC 2 or 5 to which the key assignment that is convenient to the user is applied.

The series of processes performed by the PC 2 or 5 is finished if after step S53 or S54 is completed, it is determined that none of the user (an example of the manipulator) who is using the PC 2 or 5, the keyboard (an example of the input device) which is being used, and the application which is being used is changed (Not at step S55) or if it is determined that key-assignment correspondence information 31 corresponding to the user who is currently using the PC 2 or 5 , the keyboard which is being currently used and the application which is being currently used is not stored in the key assignment storage device 4 (No at step S56).

With the above-described process, when a predetermined condition is satisfied, a user is allowed to work with an information processing apparatus to which a key assignment(s) that is convenient to the user is applied.

Although the case has been described above in which a key assignment is changed when all of the user, the keyboard, and the application match, this embodiment is not limited thereto. Alternatively, a key assignment may be applied when any one of these (the user information, the keyboard identification information, and the application information) matches or a combination of two of these (e.g., the user information and the keyboard identification information, the user information and the application information, or the keyboard identification information and the application information) matches.

This is similarly applicable to storing key assignment information in the key assignment storage device 4. The key-assignment correspondence information 31 in which all of the user information, the keyboard identification information, and the application information are associated with the key assignment information may be stored in the key assignment storage device 4. Alternatively, the key-assignment correspondence information in which one of these or a combination of two of these is associated may be stored.

Although the above example is directed to the combination of the PC and the keyboard, this embodiment is not limited thereto. For example, the PC, the keyboard, and the manipulation subject application may be replaced by a video game machine, a controller, and a game title, respectively. This makes the key configuration for an individual game title portable. In video gate competitions, it is a common practice that competitors bring their own controllers. If this embodiment is applied to a video game machine, it is possible to eliminate the need for re-setting the key configuration every time a playing user is switched in the case where one video game machine is used by plural users.

Each of a manipulator, an input device, and a manipulation subject application need not always be specified strictly. For example, if an input device is identified by a product type number, any product having the same type number can be used, which makes it unnecessary to carry a personal one. If an input device is identified by a key/button layout, any product having approximately the same structure can be used. Where a particular key is kept disabled all the time, it is not necessary to discriminate between manipulation subject applications.

The invention is not limited to the above embodiments per se and, in the practice stage, may be embodied in such a manner that constituent elements are modified in various manners without departing from the spirit and scope of the invention. And, various inventive concepts may be conceived by properly combining plural constituent elements described in the embodiments. For example, several ones of the constituent elements of the embodiment may be omitted.

What is claimed is:

1. An information processing apparatus comprising:
a transmitter configured to transmit information relating to a use situation of the information processing apparatus to an external storage device;
a receiver configured to receive, from the external storage device, key assignment information which is based on the information relating to the use situation and transmitted by the transmitter; and
a key assignment changing module configured to change a key assignment of a keyboard connected to the information processing apparatus based on the received key assignment information.

2. The apparatus of claim 1, wherein the transmitter is configured to transmit, as the information relating to the use situation, information relating to the keyboard connected to the information processing apparatus.

3. The apparatus of claim 1, wherein the transmitter is configured to transmit, as the information relating to the use situation, information relating to a user who is using the information processing apparatus.

4. The apparatus of claim 1, wherein the transmitter is configured to transmit, as the information relating to the use situation, information relating to an application which is executed by the information processing apparatus.

5. The apparatus of claim 1, wherein the transmitter is configured to transmit, as the information relating to the use situation, at least one of information relating to the keyboard connected to the information processing apparatus, information relating to a user who is using the information processing apparatus, and information relating to an application which is executed by the information processing apparatus.

6. The apparatus of claim 1, wherein:
the key assignment changing module is configured to change the key assignment according to an instruction from a user, and
when the key assignment is changed according to the instruction from the user, the transmitter is configured to transmit, to the external storage device, the information relating to the use situation of the information processing apparatus and the key assignment information in association with each other.

7. The apparatus of claim 5, wherein the transmitter is configured to transmit, as the information relating to the use situation, (i) the at least one of information relating to the keyboard connected to the information processing apparatus, information relating to a user who is using the information processing apparatus, and information relating to an application which is executed by the information processing apparatus and (ii) the key assignment information in association with each other.

8. A computer readable storage medium storing a program that cases a computer to execute a key assignment changing process, the key assignment changing process comprising:
transmitting information relating to a use situation of the computer to an external storage device;
receiving, from the external storage device, key assignment information which is based on the transmitted information relating to the use situation; and
changing a key assignment of a keyboard connected to the computer based on the received key assignment information.

9. A key assignment changing method comprising:
transmitting information relating to a use situation of an information processing apparatus to an external storage device;
receiving, from the external storage device, key assignment information which is based on the transmitted information relating to the use situation; and
changing a key assignment of a keyboard connected to the information processing apparatus based on the received key assignment information.
